(19) United States
(12) Patent Application Publication
(10) Pub. No.: US 2023/0376824 A1
(43) Pub. Date: Nov. 23, 2023

(54) ENERGY USAGE DETERMINATION FOR MACHINE LEARNING

(71) Applicant: Accenture Global Solutions Limited, Dublin (IE)

(72) Inventors: Vibhu Saujanya SHARMA, Bangalore (IN); Vikrant S. KAULGUD, Pune (IN); Jhilam BERA, West Bengal (IN); Samarth SIKAND, Jaipur (IN); Adam Patten BURDEN, Tampa, FL (US)

(21) Appl. No.: 17/663,750

(22) Filed: May 17, 2022

(51) Int. Cl. G06N 20/00; G06F 11/34

(52) U.S. Cl. CPC G06N 20/00; G06F 11/3447

(57) ABSTRACT

In some implementations, a device may receive a configuration associated with a machine learning model. The device may additionally receive a first hyperparameter set associated with the machine learning model. Accordingly, the device may estimate a first quantity of floating-point operations (FLOPs) associated with one or more epochs, for the machine learning model, based on the first hyperparameter set. The device may output, to a user, an indication of a first energy consumption associated with training the machine learning model based on the first quantity of FLOPs.

### BACKGROUND

Machine learning models, such as regression models, hidden Markov models, neural networks like convolutional neural networks or recurrent neural networks, and other types of machine learning models, are trained to fine-tune parameters of the machine learning model (e.g., weights of the machine learning model). The model may undergo training via many epochs, where each epoch is an iteration including inputting training data to the model and adjusting the parameters of the model.

### SUMMARY

Some implementations described herein relate to a method. The method may include receiving, by a device, a configuration associated with a machine learning model. The method may include receiving, by the device, a first hyperparameter set associated with the machine learning model. The method may include estimating, by the device, a first quantity of floating-point operations (FLOPs) associated with one or more epochs, for the machine learning model, based on the first hyperparameter set. The method may include outputting, to a user, an indication of a first energy consumption associated with training the machine learning model based on the first quantity of FLOPs.

Some implementations described herein relate to a device. The device may include one or more memories and one or more processors communicatively coupled to the one or more memories. The one or more processors may be configured to receive a configuration associated with a machine learning model. The one or more processors may be configured to receive a first hyperparameter set associated with the machine learning model. The one or more processors may be configured to estimate a first quantity of FLOPs associated with one or more epochs, for the machine learning model, based on the first hyperparameter set. The one or more processors may be configured to output, to a user, an indication of a first energy consumption associated with training the machine learning model based on the first quantity of FLOPs.

Some implementations described herein relate to a non-transitory computer-readable medium that stores a set of instructions for a device. The set of instructions, when executed by one or more processors of the device, may cause the device to receive a configuration associated with a machine learning model. The set of instructions, when executed by one or more processors of the device, may cause the device to receive a first hyperparameter set associated with the machine learning model. The set of instructions, when executed by one or more processors of the device, may cause the device to estimate a first quantity of FLOPs associated with one or more epochs, for the machine learning model, based on the first hyperparameter set. The set of instructions, when executed by one or more processors of the device, may cause the device to output, to a user, an indication of a first energy consumption associated with training the machine learning model based on the first quantity of FLOPs.

### BRIEF DESCRIPTION OF THE DRAWINGS

FIGS. 1A-1B are diagrams of an example implementation described herein.

FIGS. 2A-2B are diagrams of an example implementation described herein.

FIGS. 3A-3B are diagrams of training and using a model for systems and/or methods described herein.

FIG. 4 is a diagram of an example user interface (UI) for systems and/or methods described herein.

FIGS. 5A-5B are diagrams of example visual graphs output by systems and/or methods described herein.

FIGS. 6A-6B are diagrams of example visual graphs output by systems and/or methods described herein.

FIG. 7 is a diagram of an example environment in which systems and/or methods described herein may be implemented.

FIG. 8 is a diagram of example components of one or more devices of FIG. 7.

FIG. 9 is a flowchart of an example process relating to determining energy usage for a machine learning model.

### DETAILED DESCRIPTION

The following detailed description of example implementations refers to the accompanying drawings. The same reference numbers in different drawings may identify the same or similar elements.

Machine learning models consume large amounts of energy during training. However, energy consumption can vary significantly across model types, model architectures, hyperparameter sets, and epochs used. Additionally, energy consumptions may vary across different types of hardware.

By estimating energy consumption before training a machine learning model, methods and apparatus described herein help conserve power and processing resources when the model is actually trained. Some implementations described herein enable energy associated with training a machine learning model to be estimated while the model is being designed. As a result, power and processing resources are conserved during training of the model, for example, by adjusting the hyperparameter sets and epochs used for the model.

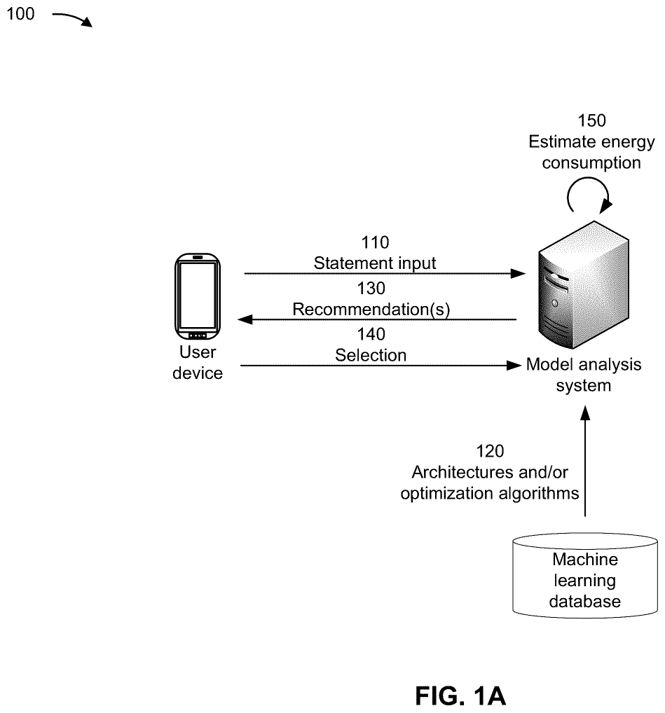

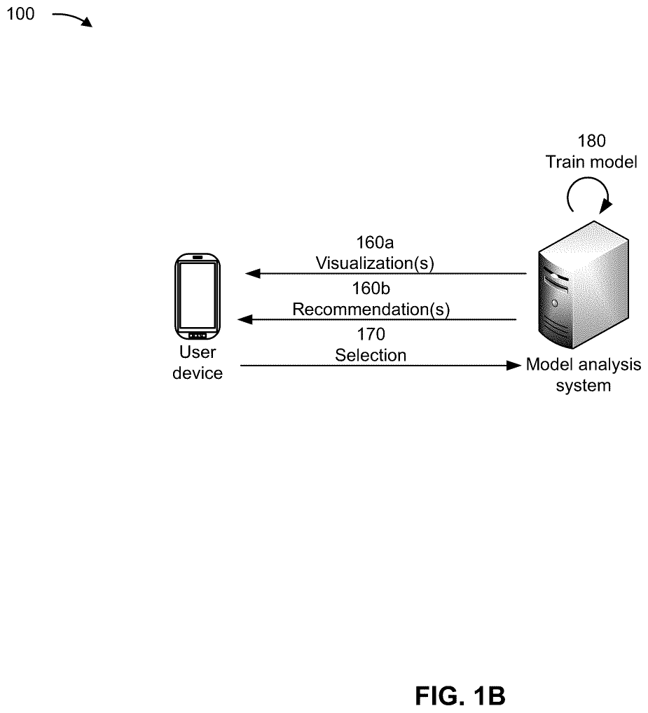

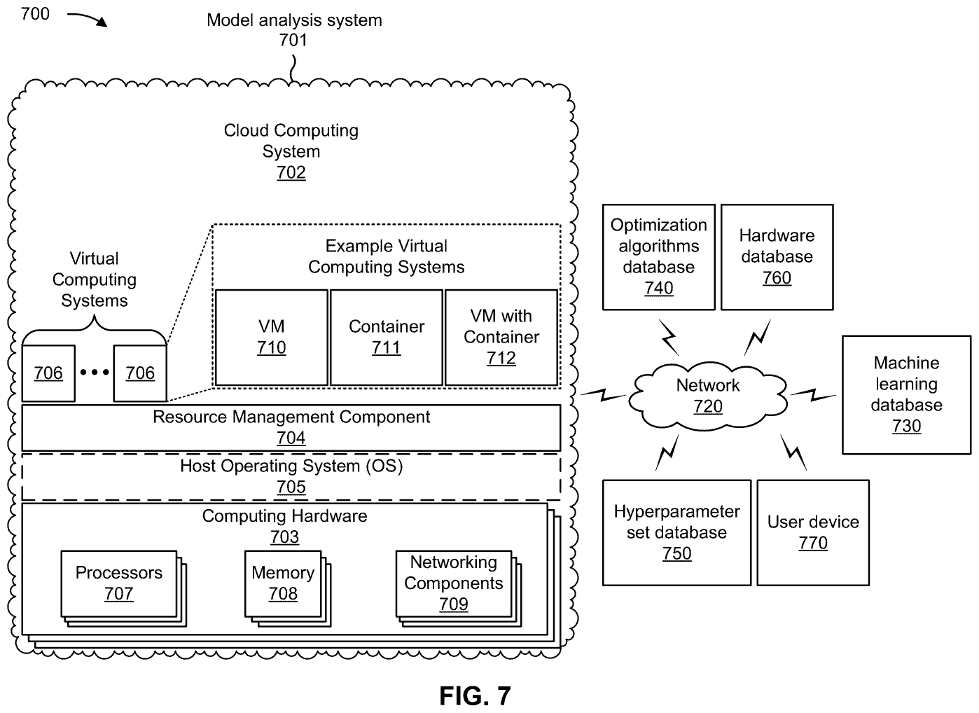

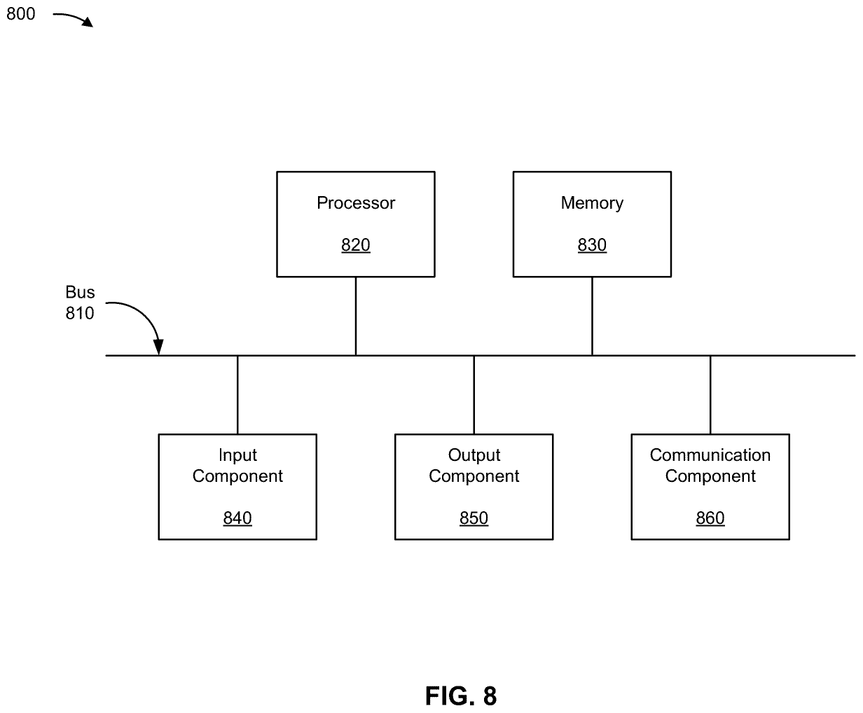

FIGS. 1A-1B are diagrams of an example implementation 100 associated with determining energy usage for a machine learning model. As shown in FIGS. 1A-1B, example implementation 100 includes a user device, a model analysis system, and a machine learning database. These are described in more detail below in connection with FIG. 7 and FIG. 8.

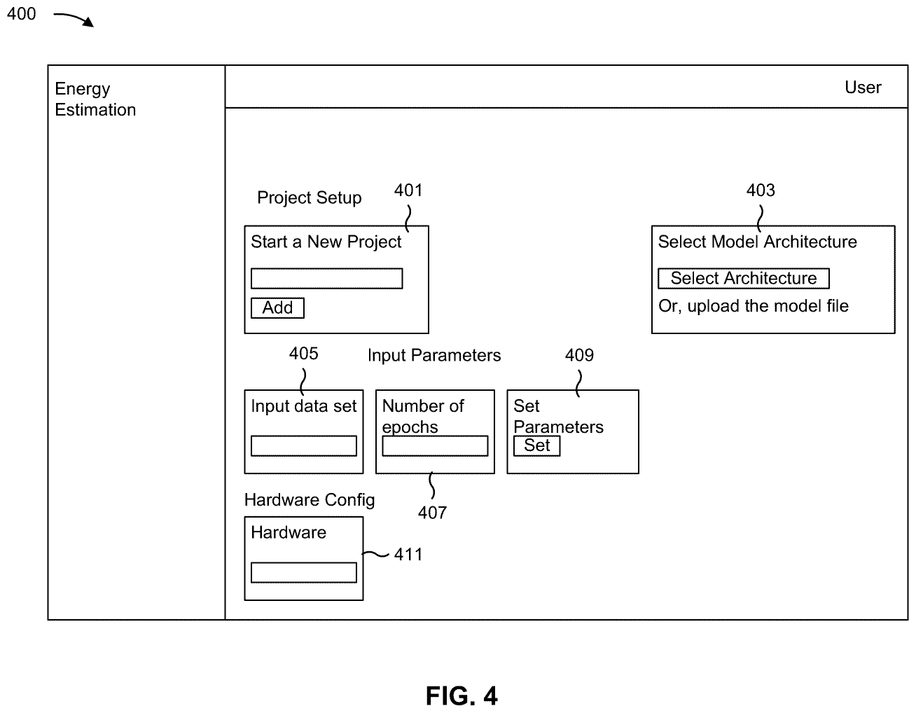

As shown by reference number 110, the user device may transmit, and the model analysis system may receive, input including a statement associated with a machine learning model to be trained. For example, the input may be a string encoding the statement. The statement may include keywords (e.g., one or more keywords) associated with a goal for the machine learning model (e.g., “image identification,” “data categorization,” “text prediction,” and/or “speech-to-text transcription,” among other examples) or a natural language indication of a problem for the machine learning model to solve (e.g., “The model will predict a next word in a sentence while a user types,” “The model should identify cats within images,” “The model will parse data from comma-separate values (CSV) files and categorize the data into spreadsheets,” among other examples). In some implementations, the model analysis system may receive the input using an interface as described in connection with FIG. 4.

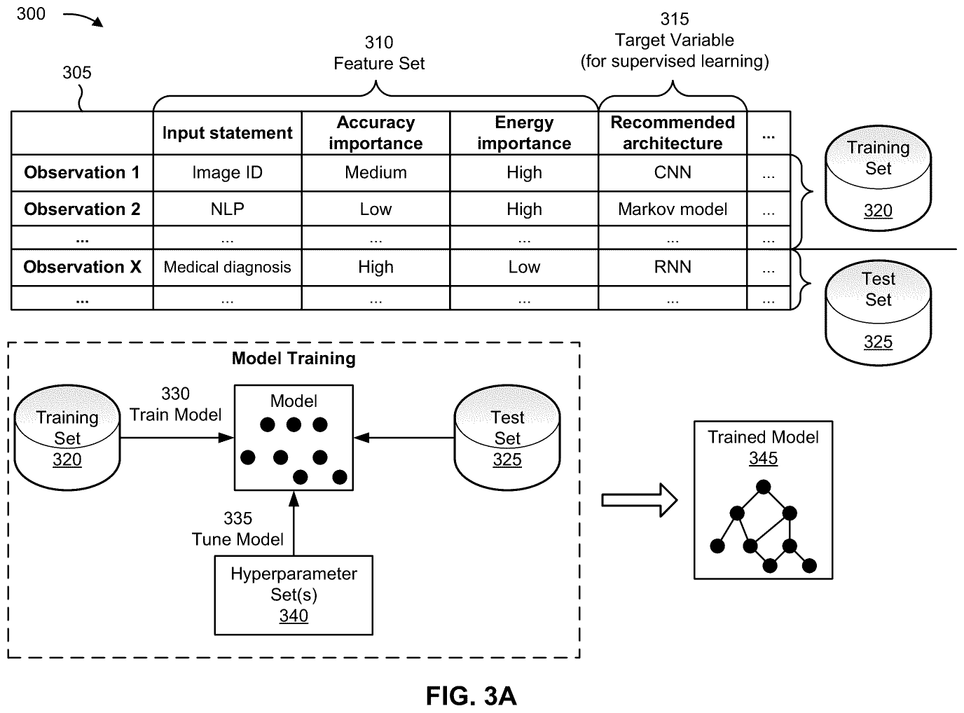

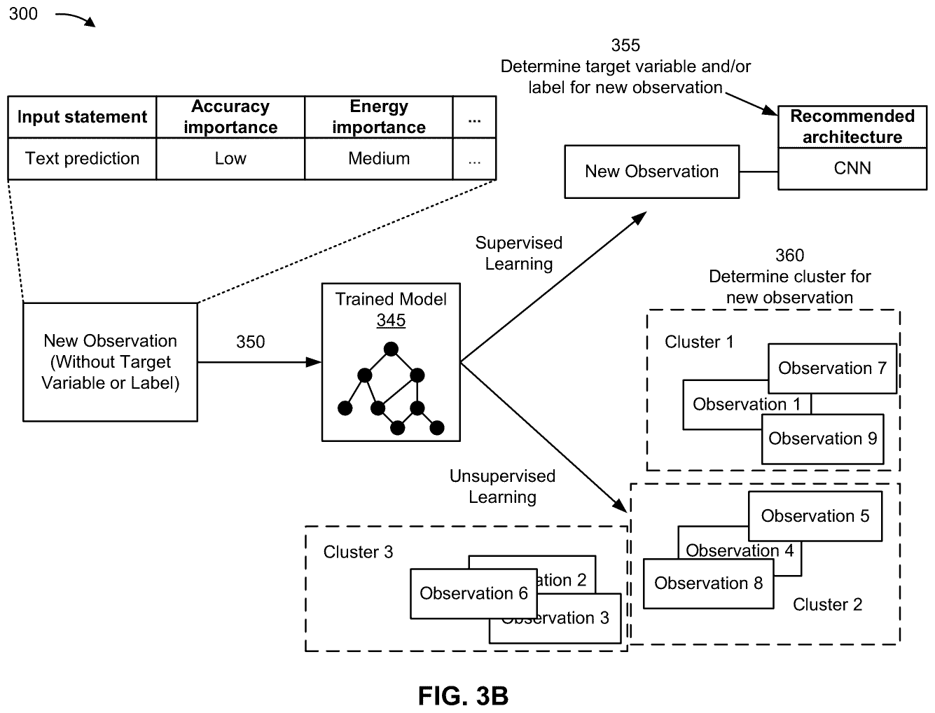

Accordingly, the model analysis system may process the input using natural language processing (NLP) and/or another type of text interpretation model. In some implementations, the model analysis system may process the input using a model trained and applied as described in connection with FIGS. 3A and 3B. Therefore, as shown by reference number 120, the model analysis system may receive (e.g., from the machine learning database) indications of machine learning architectures (e.g., one or more indications of one or more machine learning architectures) that are identified as relevant to the input. For example, the machine learning architectures may be identified as relevant based on mapping keywords in the input to keywords stored in the machine learning database in association with indications of machine learning architectures. Additionally, or alternatively, the machine learning architectures may be identified as relevant based on output from a model trained and applied as described in connection with FIGS. 3A and 3B.

Additionally with, or alternatively to, the machine learning architectures, the model analysis system may receive (e.g., from the machine learning database) indications of optimization algorithms (e.g., one or more indications of one or more machine learning architectures) that are identified as relevant to the input. For example, the optimization algorithms may be identified as relevant based on mapping keywords in the input to keywords stored in the machine learning database in association with indications of optimization algorithms. Additionally, or alternatively, the optimization algorithms may be identified as relevant based on output from a model trained and applied as described in connection with FIGS. 3A and 3B.

Therefore, as shown by reference number 130, the model analysis system may transmit, and the user device may receive, indications of recommended architectures and/or optimization algorithms. For example, the recommended architectures and/or optimization algorithms may include the relevant architectures and/or optimization algorithms, respectively, received from the machine learning database, as described in connection with reference number 120.

Accordingly, as shown by reference number 140, the user device may transmit, and the model analysis system may receive, a selection from the recommended architectures and/or optimization algorithms. Additionally, or alternatively, the user device may transmit, and the model analysis system may receive, a custom architecture and/or optimization algorithm. For example, the model analysis system may use an interface as described in connection with FIG. 4 to receive a configuration associated with a machine learning model (e.g., an architecture and an optimization algorithm) from the user device.

Furthermore, the user device may transmit, and the model analysis system may receive, a hyperparameter set associated with the machine learning model. For example, the model analysis system may use an interface as described in connection with FIG. 4 to receive an indication of the hyperparameter set.

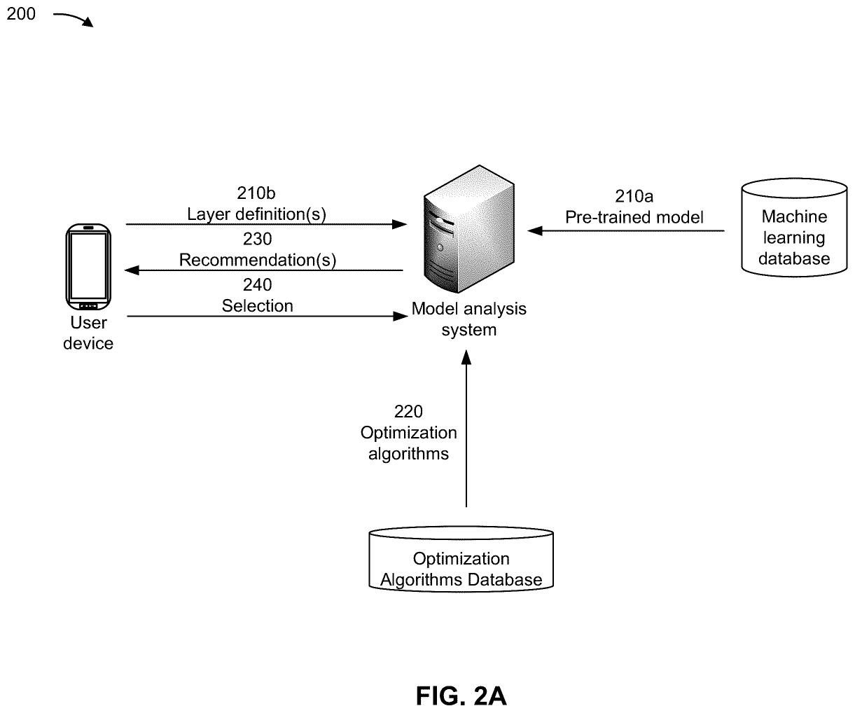

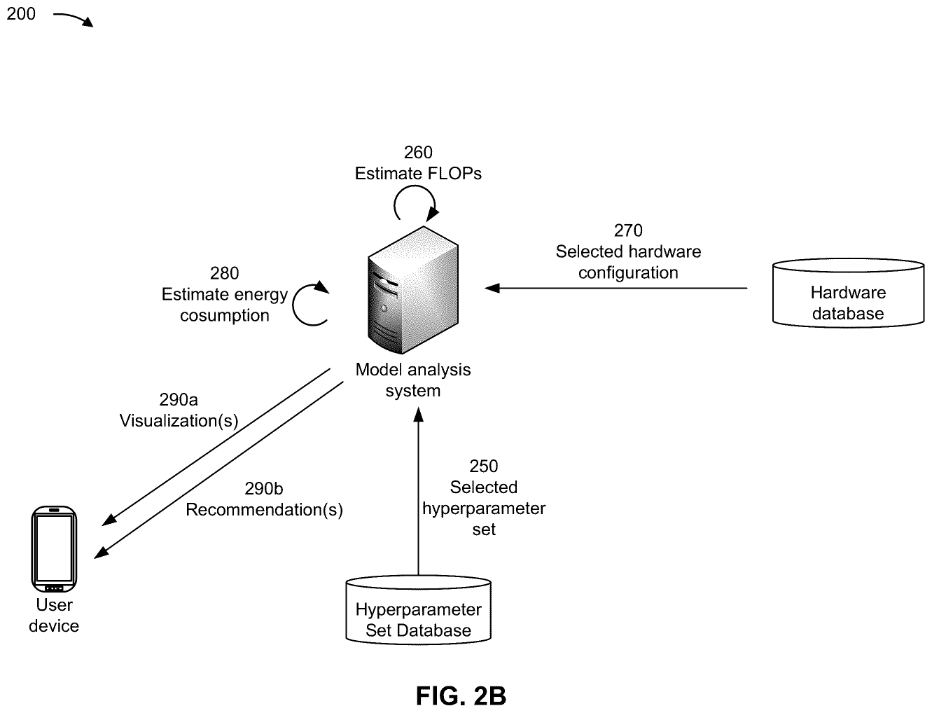

Accordingly, as shown by reference number 150, the model analysis system may estimate an energy consumption associated with training the machine learning model. For example, the energy consumption may include a quantity of floating-point operations (FLOPs) associated with one or more epochs, for the machine learning model, based on the hyperparameter set. As described in connection with FIG. 2B, the model analysis system may estimate the quantity of FLOPs based on a quantity of multiply-and-accumulate (MAC) operations associated with the machine learning architecture. Additionally, the quantity of FLOPs may be further based on an input data size associated with the machine learning model, a kernel size associated with the machine learning model, and/or a quantity of epochs used to train the machine learning model.

Additionally, or alternatively, the model analysis system may estimate the energy consumption in Joules (J), kilowatt-hours (kWh), and/or another unit associated with energy. For example, as described in connection with FIG. 2B, the user device may transmit, and the model analysis system may receive, an indication of hardware to be used for training the machine learning model. In some implementations, the model analysis system may use an interface as described in connection with FIG. 4 to receive the indication of the hardware. Accordingly, the model analysis system may determine the energy consumption associated with training the machine learning model based on a thermal design power (TDP) associated with the hardware. For example, as described in connection with FIG. 2B, the model analysis system may receive the TDP from a hardware database.

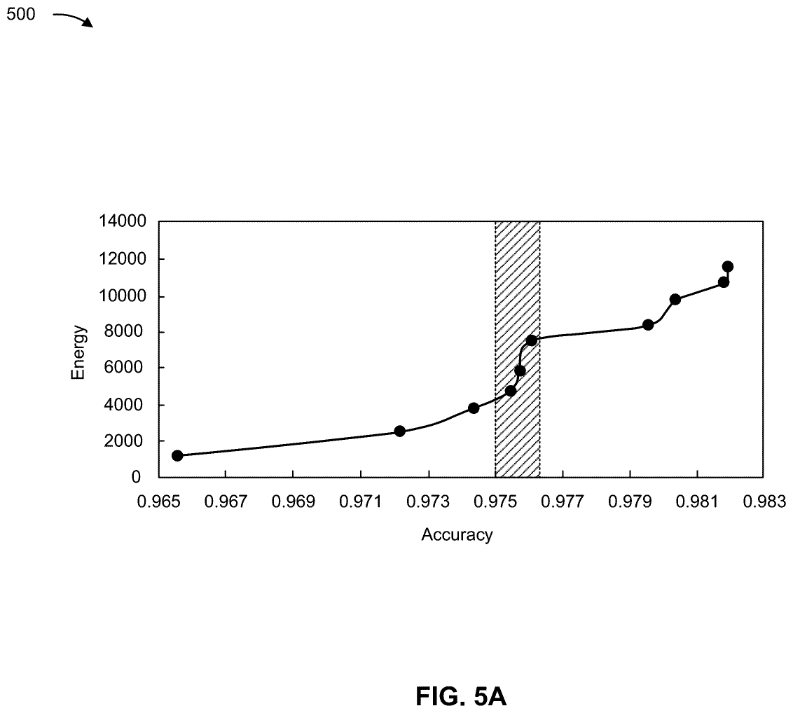

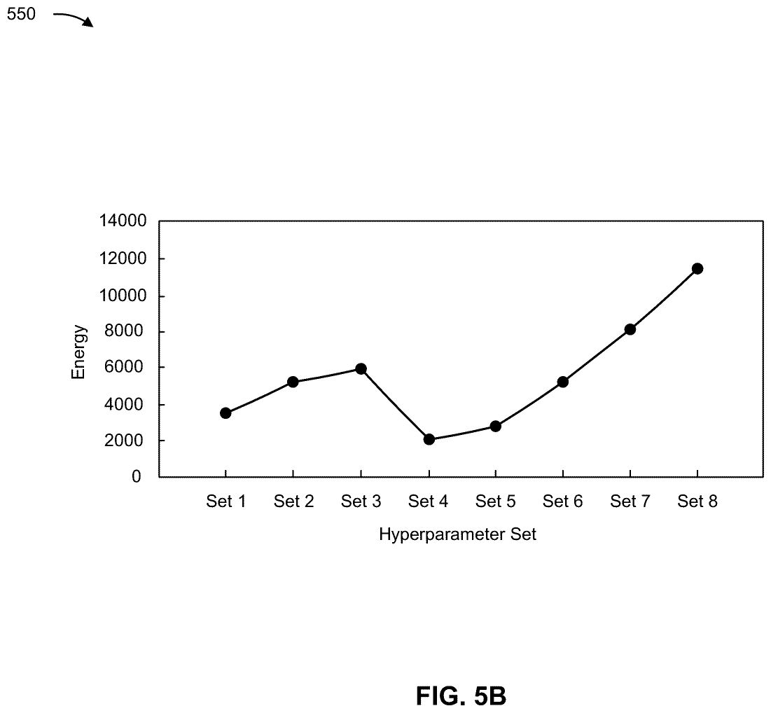

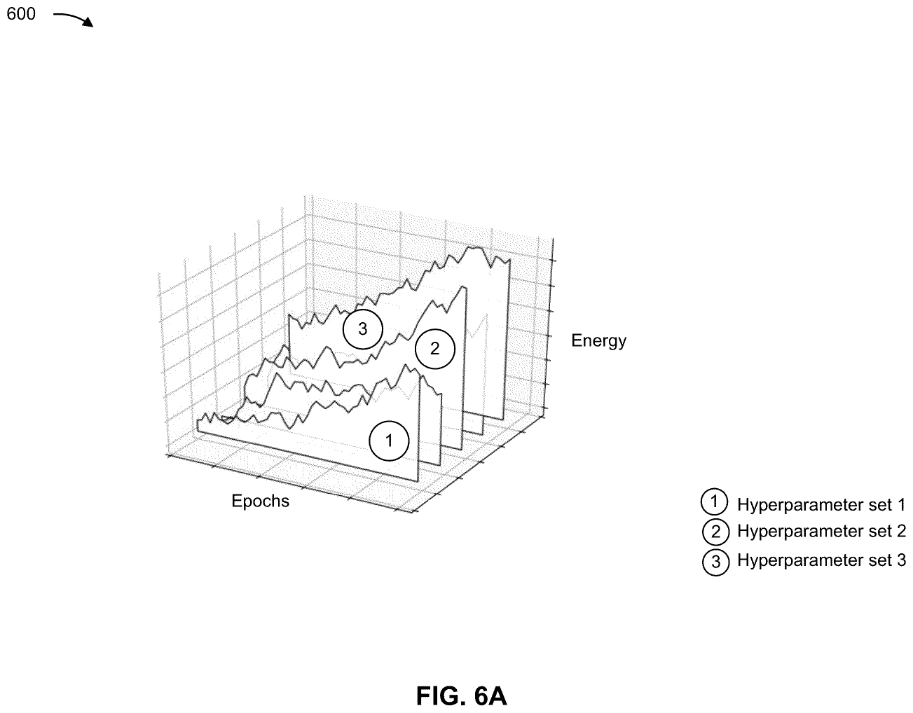

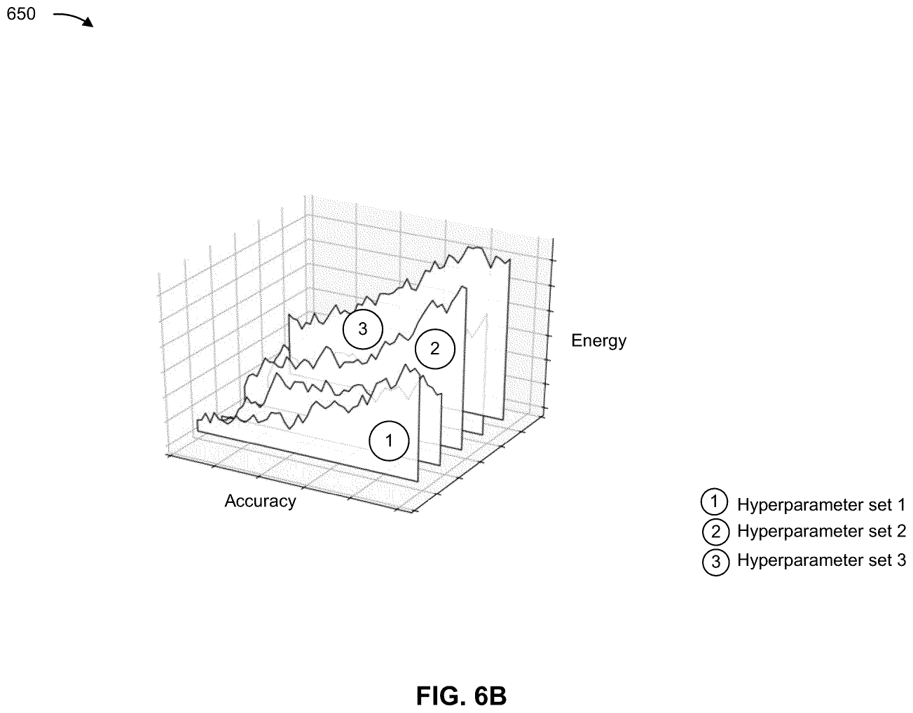

Accordingly, the model analysis system may transmit, and the user device may receive, an indication of the energy consumption associated with training the machine learning model based on the quantity of FLOPs. In some implementations, as shown by reference number 160a in FIG. 1B, the indication may include a visualization (e.g., one or more visualizations). For example, the model analysis system may use a visual graph as described in connection with FIGS. 5A, 5B, 6A, and 6B.

Additionally, or alternatively, and as shown by reference number 160b, the model analysis system may transmit, and the user device may receive, a recommendation based on the energy consumption. For example, the model analysis system may recommend a different hyperparameter set (e.g., to decrease energy consumption and/or to increase accuracy), a different quantity of epochs (e.g., to decrease energy consumption or to increase accuracy), and/or a different optimization algorithm (e.g., to decrease energy consumption and/or to increase accuracy).

Accordingly, as shown by reference number 170, the user device may transmit, and the model analysis system may receive, a selection based on the recommendation. For example, the user device may select a new hyperparameter set, a new quantity of epochs, and/or a new optimization algorithm. In some implementations, the user device and the model analysis system may iteratively perform operations associated with reference numbers 150, 160a and/or 160b, and 170 to estimate new energy consumptions based on modifications to the hyperparameter set, the quantity of epochs, and/or the optimization algorithm.

Therefore, as shown by reference number 180, the model analysis system may initiate training of the machine learning model when the user device indicates a final selection of the hyperparameter set, the quantity of epochs, and the optimization algorithm. For example, the model analysis system may store files (e.g., one or more files) that may be executed or otherwise used to train the machine learning model according to the final selection. Additionally, or alternatively, the model analysis system may transmit instructions to hardware (e.g., indicated by the user device) to begin training the machine learning model according to the final selection.

By using techniques as described in connection with FIGS. 1A-1B, the model analysis system helps reduce power and processing resources when the machine learning model is trained. For example, the model analysis system may provide visualizations and/or recommendations to adjust the hyperparameter set, quantity of epochs, and/or optimization algorithm used for the machine learning model to reduce the energy consumption associated with training the machine learning model.

As indicated above, FIGS. 1A-1B are provided as an example. Other examples may differ from what is described with regard to FIGS. 1A-1B. The number and arrangement of devices shown in FIGS. 1A-1B are provided as an example. In practice, there may be additional devices, fewer devices, different devices, or differently arranged devices than those shown in FIGS. 1A-1B. Furthermore, two or more devices shown in FIGS. 1A-1B may be implemented within a single device, or a single device shown in FIGS. 1A-1B may be implemented as multiple, distributed devices. Additionally, or alternatively, a set of devices (e.g., one or more devices) shown in FIGS. 1A-1B may perform one or more functions described as being performed by another set of devices shown in FIGS. 1A-1B.

FIGS. 2A-2B are diagrams of an example implementation 200 associated with determining energy usage for a machine learning model. As shown in FIGS. 2A-2B, example implementation 200 includes a model analysis system, a user device, an optimization algorithms database, a hyperparameter set database, and a hardware database. These are described in more detail below in connection with FIG. 7 and FIG. 8.

As shown by reference number 210a, the model analysis system may receive (e.g., from the machine learning database) an indication of a pre-trained model to use as a configuration for the machine learning model. For example, the model analysis system may identify the pre-trained model as relevant based on input from the user device (e.g., as described in connection with reference number 110 of FIG. 1A). Additionally, or alternatively, the user device may indicate the pre-trained model to use.

Additionally, or alternatively, as shown by reference number 210b, the user device may transmit, and the model analysis system may receive, definitions (e.g., one or more definitions) of layers (e.g., one or more layers) associated with the machine learning model. For example, the user device may build a configuration for the machine learning model indicating the definitions of the layers that form an architecture of the machine learning model. In some implementations, the user device may modify definitions of the layers of the pre-trained model in order to modify the configuration for the pre-trained model. The model analysis system may receive the configuration indicating the definitions using an interface as described in connection with FIG. 4.

Based on the configuration for the machine learning model, the model analysis system may receive (e.g., from the optimization algorithms database) indications of optimization algorithms (e.g., one or more indications of one or more machine learning architectures). For example, the optimization algorithms may be selected based on mapping layer definitions and/or a base architecture indicated by the configuration to layer definitions and/or base architectures stored in the optimization algorithms database in association with indications of optimization algorithms. Additionally, or alternatively, the optimization algorithms may be selected based on output from a model trained and applied as described in connection with FIGS. 3A and 3B.

Accordingly, as shown by reference number 230, the model analysis system may transmit, and the user device may receive, indications of recommended optimization algorithms. For example, the recommended optimization algorithms may include the optimization algorithms received from the machine learning database, as described in connection with reference number 220.

Further, as shown by reference number 240, the user device may transmit, and the model analysis system may receive, a selection from the recommended optimization algorithms. Additionally, or alternatively, the user device may transmit, and the model analysis system may receive, a custom optimization algorithm. For example, the model analysis system may use an interface as described in connection with FIG. 4 to receive an indication of the optimization algorithm from the user device.

As shown in FIG. 2B and by reference number 250, the model analysis system may receive (e.g., from the hyperparameter set database), an indication of the hyperparameter set associated with the machine learning model. For example, the user device may select the hyperparameter set based on recommendations from the model analysis system (e.g., as described in connection with reference number 160b of FIG. 1B). Additionally, or alternatively, the user device may indicate a hyperparameter set to use without the model analysis system providing recommendations.

As shown by reference number 260, the model analysis system may estimate a quantity of FLOPs associated with training the machine learning model. For example, the model analysis system may identify a quantity of MAC operations based on an architecture of the machine learning model and the selected optimization algorithm. The model analysis system may identify the quantity of MAC operations by estimating, for an epoch, a quantity of layers through which a training data set will pass, and activation functions and weights that will be applied in each layer. Additionally, the model analysis system may identify the quantity of MAC operations by estimating, for an epoch, how many calculations will be used by the selected optimization function to fine-tune the weights.

In some implementations, the model analysis system may generate a plurality of estimates, where each estimated quantity of FLOPs is associated with a unique quantity of epochs. Accordingly, the model analysis system may output a visualization associated with energy consumption (expressed in FLOPs) relative to epochs, as described in connection with reference number 290a. Additionally, or alternatively, the model analysis system may output a recommended quantity of epochs, as described in connection with reference number 290b, based on the estimated quantities of FLOPs.

In some implementations, the model analysis system may further estimate a plurality of accuracy values, where each accuracy value is associated with a unique, corresponding quantity of epochs. Accordingly, the model analysis system may output a visualization associated with energy consumption (expressed in FLOPs) relative to accuracy values, as described in connection with reference number 290a. Additionally, or alternatively, the model analysis system may output a recommended quantity of epochs, as described in connection with reference number 290b, based on the estimated accuracy values. For example, the model analysis system may balance energy conservation with accuracy importance. The model analysis system may apply an energy threshold and an accuracy threshold to determine the recommended quantity of epochs. Alternatively, the model analysis system may determine the recommended quantity of epochs based on output from a model trained and applied as described in connection with FIGS. 3A and 3B.

Additionally, or alternatively, the model analysis system may generate a plurality of estimates, where each estimated quantity of FLOPs is associated with a unique hyperparameter set. Accordingly, the model analysis system may output a visualization associated with energy consumption (expressed in FLOPs) relative to hyperparameter sets, as described in connection with reference number 290a. Additionally, or alternatively, the model analysis system may output a recommended hyperparameter set, as described in connection with reference number 290b, based on the estimated quantities of FLOPs.

In some implementations, the model analysis system may further estimate a plurality of accuracy values, where each accuracy value is associated with a unique, corresponding hyperparameter set. Accordingly, the model analysis system may output a visualization associated with energy consumption (expressed in FLOPs) relative to hyperparameter sets, as described in connection with reference number 290a. Additionally, or alternatively, the model analysis system may output a recommended hyperparameter set, as described in connection with reference number 290b, based on the estimated accuracy values. For example, the model analysis system may balance energy conservation with accuracy importance. The model analysis system may apply an energy threshold and an accuracy threshold to determine the recommended hyperparameter set. Alternatively, the model analysis system may determine the recommended hyperparameter set based on output from a model trained and applied as described in connection with FIGS. 3A and 3B.

The model analysis system may combine these analyses to calculate a corresponding estimate of FLOPs for each unique combination of hyperparameter set and quantity of epochs. Accordingly, the model analysis system may generate a three-dimensional visual graph as described in connection with FIG. 6A. Additionally, or alternatively, the model analysis system may calculate a corresponding estimate of FLOPs for each unique combination of hyperparameter set and accuracy value (e.g., based on quantity of epochs). Accordingly, the model analysis system may generate a three-dimensional visual graph as described in connection with FIG. 6B.

As shown by reference number 270, the model analysis system may receive (e.g., from the hardware database) an indication of a TDP associated with hardware for training the machine learning model. For example, the user device may indicate the hardware (e.g., via a serial number, a model number, and/or another indication of the hardware intended to be used for training the machine learning model).

Accordingly, as shown by reference number 280, the model analysis system may estimate energy consumption in J, kWh, and/or another unit associated with energy rather than FLOPs. For example, the model analysis system may perform any estimates described in connection with reference number 260 but with additional converting of the quantities of FLOPs to energy using the TDP associated with the hardware for training the machine learning model. Although described as using the TDP associated with the hardware, the hardware database may additionally or alternatively store algorithms associated with different types of hardware that the model analysis system uses to convert FLOPs to energy. For example, the algorithms may account for energy efficiency of particular hardware types as determined by factory specifications and/or experimental results associated with the types of hardware.

Accordingly, as shown by reference number 290a, the model analysis system may transmit, and the user device may receive, a visualization (e.g., one or more visualizations) indicating energy consumption associated with training the machine learning model. For example, the model analysis system may generate visual graphs as described in connection with FIGS. 5A, 5B, 6A, and 6B. The energy consumption may be expressed in FLOPs and/or in units of energy, as described above.

Additionally, or alternatively, as shown by reference number 290a, the model analysis system may transmit, and the user device may receive, a recommendation (e.g., one or more recommendations) associated with which hyperparameter set (or sets) and/or a quantity (or quantities) of epochs to use for the machine learning model. For example, as described above, the model analysis system may balance energy conservation with accuracy importance to determine the recommendation.

In some implementations, as described in connection with reference number 180 of FIG. 1B, the model analysis system may initiate training of the machine learning model when the user device indicates a final selection of the hyperparameter set and the quantity of epochs. For example, the model analysis system may store files (e.g., one or more files) that may be executed or otherwise used to train the machine learning model according to the final selection. Additionally, or alternatively, the model analysis system may transmit instructions to hardware (e.g., indicated by the user device) to begin training the machine learning model according to the final selection.

By using techniques as described in connection with FIGS. 2A-2B, the model analysis system helps reduce power and processing resources when the machine learning model is trained. For example, the model analysis system may provide visualizations and/or recommendations to adjust the hyperparameter set and/or the quantity of epochs used for the machine learning model to reduce the energy consumption associated with training the machine learning model.

As indicated above, FIGS. 2A-2B are provided as an example. Other examples may differ from what is described with regard to FIGS. 2A-2B. The number and arrangement of devices shown in FIGS. 2A-2B are provided as an example. In practice, there may be additional devices, fewer devices, different devices, or differently arranged devices than those shown in FIGS. 2A-2B. Furthermore, two or more devices shown in FIGS. 2A-2B may be implemented within a single device, or a single device shown in FIGS. 2A-2B may be implemented as multiple, distributed devices. Additionally, or alternatively, a set of devices (e.g., one or more devices) shown in FIGS. 2A-2B may perform one or more functions described as being performed by another set of devices shown in FIGS. 2A-2B.

FIG. 3A is a diagram illustrating an example 300 of training and using a machine learning model in connection with recommending machine learning algorithms. The machine learning model training described herein may be performed using a machine learning system. The machine learning system may include or may be included in a computing device, a server, a cloud computing environment, or the like, such as the model analysis system described in more detail below.

As shown by reference number 305, a machine learning model may be trained using a set of observations. The set of observations may be obtained and/or input from training data (e.g., historical data), such as data gathered during one or more processes described herein. For example, the set of observations may include data gathered from a machine learning database, an optimization algorithms database, a hyperparameter set database, and/or a hardware database, as described elsewhere herein. In some implementations, the machine learning system may receive the set of observations (e.g., as input) from a user device, as described elsewhere herein.

As shown by reference number 310, a feature set may be derived from the set of observations. The feature set may include a set of variables. A variable may be referred to as a feature. A specific observation may include a set of variable values corresponding to the set of variables. A set of variable values may be specific to an observation. In some cases, different observations may be associated with different sets of variable values, sometimes referred to as feature values. In some implementations, the machine learning system may determine variables for a set of observations and/or variable values for a specific observation based on input received from the machine learning database, the optimization algorithms database, the hyperparameter set database, the hardware database, and/or the user device. For example, the machine learning system may identify a feature set (e.g., one or more features and/or corresponding feature values) from structured data input to the machine learning system, such as by extracting data from a particular column of a table, extracting data from a particular field of a form and/or a message, and/or extracting data received in a structured data format. Additionally, or alternatively, the machine learning system may receive input from an operator to determine features and/or feature values. In some implementations, the machine learning system may perform natural language processing and/or another feature identification technique to extract features (e.g., variables) and/or feature values (e.g., variable values) from text (e.g., unstructured data) input to the machine learning system, such as by identifying keywords and/or values associated with those keywords from the text.

As an example, a feature set for a set of observations may include a first feature of an input statement, a second feature of an accuracy importance, a third feature of an energy importance, and so on. As shown, for a first observation, the first feature may have a value of “image ID” (or image identification), the second feature may have a value of medium, the third feature may have a value of high, and so on. These features and feature values are provided as examples, and may differ in other examples. For example, the feature set may include one or more of the following features: a hardware configuration, a selected architecture, a quantity of epochs, a desired accuracy, a selected hyperparameter set, and/or a selected optimization algorithm, among other examples. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources and/or memory resources) used to train the machine learning model.

As shown by reference number 315, the set of observations may be associated with a target variable. The target variable may represent a variable having a numeric value (e.g., an integer value or a floating point value), may represent a variable having a numeric value that falls within a range of values or has some discrete possible values, may represent a variable that is selectable from one of multiple options (e.g., one of multiples classes, classifications, or labels), or may represent a variable having a Boolean value (e.g., 0 or 1, True or False, Yes or No), among other examples. A target variable may be associated with a target variable value, and a target variable value may be specific to an observation. In some cases, different observations may be associated with different target variable values. In example 300, the target variable is a recommended architecture, which has a value of convolutional neural network (CNN) for the first observation.

The feature set and target variable described above are provided as examples, and other examples may differ from what is described above. For example, for a target variable of recommended optimization algorithm, the feature set may include an accuracy importance, an energy importance, a selected architecture, and/or a selected hyperparameter set. In another example, for a target variable of recommended hyperparameter set, the feature set may include an accuracy importance, an energy importance, a selected architecture, and/or a selected optimization algorithm. In another example, for a target variable of recommended quantity of epochs, the feature set may include an accuracy importance, an energy importance, a selected architecture, a selected hyperparameter set, and/or a selected optimization algorithm.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model or a predictive model. When the target variable is associated with continuous target variable values (e.g., a range of numbers), the machine learning model may employ a regression technique. When the target variable is associated with categorical target variable values (e.g., classes or labels), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, or an automated signal extraction model. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 320 that includes a first subset of observations, of the set of observations, and a test set 325 that includes a second subset of observations of the set of observations. The training set 320 may be used to train (e.g., fit or tune) the machine learning model, while the test set 325 may be used to evaluate a machine learning model that is trained using the training set 320. For example, for supervised learning, the test set 325 may be used for initial model training using the first subset of observations, and the test set 325 may be used to test whether the trained model accurately predicts target variables in the second subset of observations. In some implementations, the machine learning system may partition the set of observations into the training set 320 and the test set 325 by including a first portion or a first percentage of the set of observations in the training set 320 (e.g., 75%, 80%, or 85%, among other examples) and including a second portion or a second percentage of the set of observations in the test set 325 (e.g., 25%, 20%, or 15%, among other examples). In some implementations, the machine learning system may randomly select observations to be included in the training set 320 and/or the test set 325.

As shown by reference number 330, the machine learning system may train a machine learning model using the training set 320. This training may include executing, by the machine learning system, a machine learning algorithm to determine a set of model parameters based on the training set 320. In some implementations, the machine learning algorithm may include a regression algorithm (e.g., linear regression or logistic regression), which may include a regularized regression algorithm (e.g., Lasso regression, Ridge regression, or Elastic-Net regression). Additionally, or alternatively, the machine learning algorithm may include a decision tree algorithm, which may include a tree ensemble algorithm (e.g., generated using bagging and/or boosting), a random forest algorithm, or a boosted trees algorithm. A model parameter may include an attribute of a machine learning model that is learned from data input into the model (e.g., the training set 320). For example, for a regression algorithm, a model parameter may include a regression coefficient (e.g., a weight). For a decision tree algorithm, a model parameter may include a decision tree split location, as an example.

As shown by reference number 335, the machine learning system may use one or more hyperparameter sets 340 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the machine learning model to the training set 320. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

To train a machine learning model, the machine learning system may identify a set of machine learning algorithms to be trained (e.g., based on operator input that identifies the one or more machine learning algorithms and/or based on random selection of a set of machine learning algorithms), and may train the set of machine learning algorithms (e.g., independently for each machine learning algorithm in the set) using the training set 320. The machine learning system may tune each machine learning algorithm using one or more hyperparameter sets 340 (e.g., based on operator input that identifies hyperparameter sets 340 to be used and/or based on randomly generating hyperparameter values). The machine learning system may train a particular machine learning model using a specific machine learning algorithm and a corresponding hyperparameter set 340. In some implementations, the machine learning system may train multiple machine learning models to generate a set of model parameters for each machine learning model, where each machine learning model corresponds to a different combination of a machine learning algorithm and a hyperparameter set 340 for that machine learning algorithm.

In some implementations, the machine learning system may perform cross-validation when training a machine learning model. Cross validation can be used to obtain a reliable estimate of machine learning model performance using only the training set 320, and without using the test set 325, such as by splitting the training set 320 into a number of groups (e.g., based on operator input that identifies the number of groups and/or based on randomly selecting a number of groups) and using those groups to estimate model performance. For example, using k-fold cross-validation, observations in the training set 320 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k−1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, or a standard error across cross-validation scores.

In some implementations, the machine learning system may perform cross-validation when training a machine learning model by splitting the training set into a number of groups (e.g., based on operator input that identifies the number of groups and/or based on randomly selecting a number of groups). The machine learning system may perform multiple training procedures and may generate a cross-validation score for each training procedure. The machine learning system may generate an overall cross-validation score for each hyperparameter set 340 associated with a particular machine learning algorithm. The machine learning system may compare the overall cross-validation scores for different hyperparameter sets 340 associated with the particular machine learning algorithm, and may select the hyperparameter set 340 with the best (e.g., highest accuracy, lowest error, or closest to a desired threshold) overall cross-validation score for training the machine learning model. The machine learning system may then train the machine learning model using the selected hyperparameter set 340, without cross-validation (e.g., using all of the data in the training set 320 without any hold-out groups), to generate a single machine learning model for a particular machine learning algorithm. The machine learning system may then test this machine learning model using the test set 325 to generate a performance score, such as a mean squared error (e.g., for regression), a mean absolute error (e.g., for regression), or an area under receiver operating characteristic curve (e.g., for classification). If the machine learning model performs adequately (e.g., with a performance score that satisfies a threshold), then the machine learning system may store that machine learning model as a trained machine learning model 345 to be used to analyze new observations, as described below in connection with FIG. 3B.

In some implementations, the machine learning system may perform cross-validation, as described above, for multiple machine learning algorithms (e.g., independently), such as a regularized regression algorithm, different types of regularized regression algorithms, a decision tree algorithm, or different types of decision tree algorithms. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 320 (e.g., without cross-validation), and may test each machine learning model using the test set 325 to generate a corresponding performance score for each machine learning model. The machine learning model may compare the performance scores for each machine learning model, and may select the machine learning model with the best (e.g., highest accuracy, lowest error, or closest to a desired threshold) performance score as the trained machine learning model 345.

FIG. 3B is a diagram illustrating applying the trained machine learning model 345 to a new observation. As shown by reference number 350, the machine learning system may receive a new observation (or a set of new observations), and may input the new observation to the machine learning model 345. As shown, the new observation may include a first feature of an input statement including “text prediction”, a second feature of an accuracy importance as low, a third feature of an energy importance as medium, and so on, as an example. The machine learning system may apply the trained machine learning model 345 to the new observation to generate an output (e.g., a result). The type of output may depend on the type of machine learning model and/or the type of machine learning task being performed. For example, the output may include a predicted (e.g., estimated) value of target variable (e.g., a value within a continuous range of values, a discrete value, a label, a class, or a classification), such as when supervised learning is employed. Additionally, or alternatively, the output may include information that identifies a cluster to which the new observation belongs and/or information that indicates a degree of similarity between the new observation and one or more prior observations (e.g., which may have previously been new observations input to the machine learning model and/or observations used to train the machine learning model), such as when unsupervised learning is employed.

In some implementations, the trained machine learning model 345 may predict a value of CNN for the target variable of recommended architecture for the new observation, as shown by reference number 355. Based on this prediction (e.g., based on the value having a particular label or classification or based on the value satisfying or failing to satisfy a threshold), the machine learning system may provide a recommendation and/or output for determination of a recommendation, such as a recommended pre-trained CNN to use. Additionally, or alternatively, the machine learning system may perform an automated action and/or may cause an automated action to be performed (e.g., by instructing another device to perform the automated action), such as selecting a CNN base architecture. As another example, if the machine learning system were to predict a value of recurrent neural network (RNN) for the target variable of recommended architecture, then the machine learning system may provide a different recommendation (e.g., a recommended pre-trained RNN to use) and/or may perform or cause performance of a different automated action (e.g., selecting an RNN base architecture). In some implementations, the recommendation and/or the automated action may be based on the target variable value having a particular label (e.g., classification or categorization) and/or may be based on whether the target variable value satisfies one or more threshold (e.g., whether the target variable value is greater than a threshold, is less than a threshold, is equal to a threshold, or falls within a range of threshold values).

In some implementations, the trained machine learning model 345 may classify (e.g., cluster) the new observation in a cluster, as shown by reference number 360. The observations within a cluster may have a threshold degree of similarity. As an example, if the machine learning system classifies the new observation in a first cluster (e.g., energy conscious), then the machine learning system may provide a first recommendation, such as a CNN architecture. Additionally, or alternatively, the machine learning system may perform a first automated action and/or may cause a first automated action to be performed (e.g., by instructing another device to perform the automated action) based on classifying the new observation in the first cluster, such as selecting a CNN base architecture. As another example, if the machine learning system were to classify the new observation in a second cluster (e.g., accuracy conscious), then the machine learning system may provide a second (e.g., different) recommendation (e.g., an RNN architecture) and/or may perform or cause performance of a second (e.g., different) automated action, such as selecting an RNN base architecture.

The recommendations, actions, and clusters described above are provided as examples, and other examples may differ from what is described above. For example, the recommendations associated with text-related statements may include a hidden Markov model architecture. The actions associated with text-related statements may include, for example, selecting a Markov model base architecture. The clusters associated with text-related statements may include, for example, energy conscious and accuracy conscious clusters.

In this way, the machine learning system may apply a rigorous and automated process to recommending machine learning model architectures, hyperparameter sets, optimization algorithms, and/or quantities of epochs. The machine learning system enables recognition and/or identification of tens, hundreds, thousands, or millions of features and/or feature values for tens, hundreds, thousands, or millions of observations, thereby increasing accuracy and consistency and reducing delay associated with building a machine learning model relative to requiring computing resources to be allocated for tens, hundreds, or thousands of operators to build and test multiple different architectures, hyperparameter sets, optimization algorithms, and/or quantities of epochs using the features or feature values.

As indicated above, FIGS. 3A-3B are provided as an example. Other examples may differ from what is described in connection with FIGS. 3A-3B. For example, the machine learning model may be trained using a different process than what is described in connection with FIG. 3A. Additionally, or alternatively, the machine learning model may employ a different machine learning algorithm than what is described in connection with FIGS. 3A-3B, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

FIG. 4 is a diagram of an example interface 400 associated with receiving a configuration associated with a machine learning model. Example interface 400 may be used (e.g., by a model analysis system described herein) to receive input (e.g., from a user via a user device, as described herein).

As shown in FIG. 4, the interface 400 may include an input component 401 for initiating a new project or loading a previous project. For example, the input component 401 may include a text box for indicating a location (e.g., on a hard drive or another type of persistent memory) for storing the new project or from which the previous project should be loaded.

As further shown in FIG. 4, the interface 400 may include an input component 403 for indicating an architecture for a machine learning model of the project. For example, the input component 403 may include a selector to allow selection of an architecture from a plurality of stored architectures. Additionally, or alternatively, the input component 403 may include a text box for indicating a location (e.g., on a hard drive or another type of persistent memory) of a file indicating the architecture.

As shown in FIG. 4, the interface 400 may include an input component 405 associated with a data set for training the machine learning model of the project. For example, the input component 405 may include a text box for indicating a location (e.g., on a hard drive or another type of persistent memory) from which the data set should be loaded.

As further shown in FIG. 4, the interface 400 may include an input component 407 for indicating a quantity of epochs for training the machine learning model of the project. For example, the input component 407 may include a text box for indicating the quantity.

As shown in FIG. 4, the interface 400 may include an input component 409 associated with a hyperparameter set for the machine learning model of the project. For example, the input component 409 may include a selector to allow selection of a hyperparameter set from a plurality of stored hyperparameter sets. Additionally, or alternatively, the input component 409 may include a text box for indicating a location (e.g., on a hard drive or another type of persistent memory) of a file indicating the hyperparameter set.

As further shown in FIG. 4, the interface 400 may include an input component 411 for indicating a hardware configuration on which the machine learning model will be trained. For example, the input component 411 may include a selector to allow selection of a hardware configuration from a plurality of stored hardware configurations. Additionally, or alternatively, the input component 411 may include a text box for indicating a location (e.g., on a hard drive or another type of persistent memory) of a file indicating the hardware configuration.

FIGS. 5A and 5B are diagrams of example visual graphs 500 and 550, respectively, associated with indicating energy usage for a machine learning model. A visual graph as illustrated by example graph 500 and/or example graph 550 may be used (e.g., by a model analysis system described herein) as output (e.g., to a user via a user device, as described herein).

As shown in FIG. 5A, the visual graph 500 shows a plurality of accuracy values on a first axis relative to a plurality of energy consumptions on a second axis. For example, as described in connection with FIG. 2B, the model analysis system may estimate a plurality of accuracies associated with training the machine learning model based on a plurality of quantities of epochs and further estimate an energy consumption for each accuracy based on the quantity of epochs associated with that accuracy. Therefore, the visual graph 500 includes the accuracy values relative to the energy consumptions. Although FIG. 5A shows the accuracy values on a horizontal axis and the energy consumptions on a vertical axis, other implementations may include the accuracy values on the vertical axis and the energy consumptions on the horizontal axis.

As further shown in FIG. 5A, the visual graph 500 may include an indication of a portion of the visual graph 500 associated with an inflection point. For example, FIG. 5A includes a shaded region of the visual graph 500 including an area of the visual graph 500 that satisfies a distance threshold relative to the inflection point. Other indications may include a text label, bounding lines for the region, and/or another visual indication of the region associated with the inflection point. As a result, the inflection point may readily allow selection of an accuracy (and thus an associated quantity of epochs) that is energy-efficient.

As shown in FIG. 5B, the visual graph 550 shows a plurality of hyperparameter sets on a first axis relative to a plurality of energy consumptions on a second axis. For example, as described in connection with FIG. 2B, the model analysis system may estimate at least one energy consumption for each hyperparameter set. Therefore, the visual graph 550 includes the hyperparameter sets relative to the energy consumptions. Although FIG. 5B shows the hyperparameter sets on a horizontal axis and the energy consumptions on a vertical axis, other implementations may include the hyperparameter sets on the vertical axis and the energy consumptions on the horizontal axis.

FIGS. 6A and 6B are diagrams of example visual graphs 600 and 650, respectively, associated with indicating energy usage for a machine learning model. A visual graph as illustrated by example graph 600 and/or example graph 650 may be used (e.g., by a model analysis system described herein) as output (e.g., to a user via a user device, as described herein).

As shown in FIG. 6A, the visual graph 600 shows a plurality of hyperparameter sets on a first axis relative to a plurality of energy consumptions on a second axis and a plurality of quantities of epochs on a third axis. For example, as described in connection with FIG. 2B, the model analysis system may estimate energy consumptions associated with training the machine learning model based on a plurality of hyperparameter sets. Additionally, the model analysis system may, for each hyperparameter set, determine a plurality of energy consumptions associated with a corresponding plurality of quantities of epochs. Although FIG. 6A shows the hyperparameter sets and the quantities of epochs on horizontal axes and the energy consumptions on a vertical axis, other implementations may include the energy consumptions on a horizontal axis and one of the hyperparameter sets and the quantities of epochs on the vertical axis.

As shown in FIG. 6B, the visual graph 650 shows a plurality of hyperparameter sets on a first axis relative to a plurality of energy consumptions on a second axis and a plurality of accuracy values on a third axis. For example, as described in connection with FIG. 2B, the model analysis system may estimate a plurality of accuracies, for each hyperparameter set, based on a plurality of quantities of epochs. Additionally, the model analysis system may, for each hyperparameter set, determine a plurality of energy consumptions associated with the corresponding plurality of accuracy values estimated using the corresponding plurality of quantities of epochs. Although FIG. 6B shows the hyperparameter sets and the accuracy values on horizontal axes and the energy consumptions on a vertical axis, other implementations may include the energy consumptions on a horizontal axis and one of the hyperparameter sets and the accuracy values on the vertical axis.

As indicated above, FIGS. 4, 5A, 5B, 6A, and 6B are provided as examples. Other examples may differ from what is described with regard to FIGS. 4, 5A, 5B, 6A, and 6B.

FIG. 7 is a diagram of an example environment 700 in which systems and/or methods described herein may be implemented. As shown in FIG. 7, environment 700 may include a model analysis system 701, which may include one or more elements of and/or may execute within a cloud computing system 702. The cloud computing system 702 may include one or more elements 703-712, as described in more detail below. As further shown in FIG. 7, environment 700 may include a network 720, a machine learning database 730, an optimization algorithms database 740, a hyperparameter set database 750, a hardware database 760, and/or a user device 770. Devices and/or elements of environment 700 may interconnect via wired connections and/or wireless connections.

The cloud computing system 702 includes computing hardware 703, a resource management component 704, a host operating system (OS) 705, and/or one or more virtual computing systems 706. The cloud computing system 702 may execute on, for example, an Amazon Web Services platform, a Microsoft Azure platform, or a Snowflake platform. The resource management component 704 may perform virtualization (e.g., abstraction) of computing hardware 703 to create the one or more virtual computing systems 706. Using virtualization, the resource management component 704 enables a single computing device (e.g., a computer or a server) to operate like multiple computing devices, such as by creating multiple isolated virtual computing systems 706 from computing hardware 703 of the single computing device. In this way, computing hardware 703 can operate more efficiently, with lower power consumption, higher reliability, higher availability, higher utilization, greater flexibility, and lower cost than using separate computing devices.

Computing hardware 703 includes hardware and corresponding resources from one or more computing devices. For example, computing hardware 703 may include hardware from a single computing device (e.g., a single server) or from multiple computing devices (e.g., multiple servers), such as multiple computing devices in one or more data centers. As shown, computing hardware 703 may include one or more processors 707, one or more memories 708, and/or one or more networking components 709. Examples of a processor, a memory, and a networking component (e.g., a communication component) are described elsewhere herein.

The resource management component 704 includes a virtualization application (e.g., executing on hardware, such as computing hardware 703) capable of virtualizing computing hardware 703 to start, stop, and/or manage one or more virtual computing systems 706. For example, the resource management component 704 may include a hypervisor (e.g., a bare-metal or Type 1 hypervisor, a hosted or Type 2 hypervisor, or another type of hypervisor) or a virtual machine monitor, such as when the virtual computing systems 706 are virtual machines 710. Additionally, or alternatively, the resource management component 704 may include a container manager, such as when the virtual computing systems 706 are containers 711. In some implementations, the resource management component 704 executes within and/or in coordination with a host operating system 705.

A virtual computing system 706 includes a virtual environment that enables cloud-based execution of operations and/or processes described herein using computing hardware 703. As shown, a virtual computing system 706 may include a virtual machine 710, a container 711, or a hybrid environment 712 that includes a virtual machine and a container, among other examples. A virtual computing system 706 may execute one or more applications using a file system that includes binary files, software libraries, and/or other resources required to execute applications on a guest operating system (e.g., within the virtual computing system 706) or the host operating system 705.

Although the model analysis system 701 may include one or more elements 703-712 of the cloud computing system 702, may execute within the cloud computing system 702, and/or may be hosted within the cloud computing system 702, in some implementations, the model analysis system 701 may not be cloud-based (e.g., may be implemented outside of a cloud computing system) or may be partially cloud-based. For example, the model analysis system 701 may include one or more devices that are not part of the cloud computing system 702, such as device 800 of FIG. 8, which may include a standalone server or another type of computing device. The model analysis system 701 may perform one or more operations and/or processes described in more detail elsewhere herein.

Network 720 includes one or more wired and/or wireless networks. For example, network 720 may include a cellular network, a public land mobile network (PLMN), a local area network (LAN), a wide area network (WAN), a private network, the Internet, and/or a combination of these or other types of networks. The network 720 enables communication among the devices of environment 700.

The machine learning database 730 includes one or more devices capable of receiving, generating, storing, processing, and/or providing information associated with machine learning model architectures, as described elsewhere herein. The machine learning database 730 may include a communication device and/or a computing device. For example, the machine learning database 730 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The machine learning database 730 may communicate with one or more other devices of environment 700, as described elsewhere herein.

The optimization algorithms database 740 includes one or more devices capable of receiving, generating, storing, processing, and/or providing information associated with optimization algorithms (e.g., loss functions), as described elsewhere herein. The optimization algorithms database 740 may include a communication device and/or a computing device. For example, the optimization algorithms database 740 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The optimization algorithms database 740 may communicate with one or more other devices of environment 700, as described elsewhere herein.

The hyperparameter set database 750 includes one or more devices capable of receiving, generating, storing, processing, and/or providing information associated with hyperparameter sets, as described elsewhere herein. The hyperparameter set database 750 may include a communication device and/or a computing device. For example, the hyperparameter set database 750 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The hyperparameter set database 750 may communicate with one or more other devices of environment 700, as described elsewhere herein.

The hardware database 760 includes one or more devices capable of receiving, generating, storing, processing, and/or providing information associated with hardware properties (e.g., TDP values), as described elsewhere herein. The hardware database 760 may include a communication device and/or a computing device. For example, the hardware database 760 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The hardware database 760 may communicate with one or more other devices of environment 700, as described elsewhere herein.

The user device 770 includes one or more devices capable of receiving, generating, storing, processing, and/or providing information associated with machine learning models, as described elsewhere herein. The user device 770 may include a communication device and/or a computing device. For example, the user device 770 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of environment 700 may perform one or more functions described as being performed by another set of devices of environment 700.

FIG. 8 is a diagram of example components of a device 800, which may correspond to a model analysis system 701, a machine learning database 730, an optimization algorithms database 740, a hyperparameter set database 750, and/or a hardware database 760. In some implementations, a model analysis system 701, a machine learning database 730, an optimization algorithms database 740, a hyperparameter set database 750, and/or a hardware database 760 may each include one or more devices 800 and/or one or more components of device 800. As shown in FIG. 8, device 800 may include a bus 810, a processor 820, a memory 830, an input component 840, an output component 850, and a communication component 860.

Bus 810 includes one or more components that enable wired and/or wireless communication among the components of device 800. Bus 810 may couple together two or more components of FIG. 8, such as via operative coupling, communicative coupling, electronic coupling, and/or electric coupling. Processor 820 includes a central processing unit, a graphics processing unit, a microprocessor, a controller, a microcontroller, a digital signal processor, a field-programmable gate array, an application-specific integrated circuit, and/or another type of processing component. Processor 820 is implemented in hardware, firmware, or a combination of hardware and software. In some implementations, processor 820 includes one or more processors capable of being programmed to perform one or more operations or processes described elsewhere herein.

Memory 830 includes volatile and/or nonvolatile memory. For example, memory 830 may include random access memory (RAM), read only memory (ROM), a hard disk drive, and/or another type of memory (e.g., a flash memory, a magnetic memory, and/or an optical memory). Memory 830 may include internal memory (e.g., RAM, ROM, or a hard disk drive) and/or removable memory (e.g., removable via a universal serial bus connection). Memory 830 may be a non-transitory computer-readable medium. Memory 830 stores information, instructions, and/or software (e.g., one or more software applications) related to the operation of device 800. In some implementations, memory 830 includes one or more memories that are coupled to one or more processors (e.g., processor 820), such as via bus 810.

Input component 840 enables device 800 to receive input, such as user input and/or sensed input. For example, input component 840 may include a touch screen, a keyboard, a keypad, a mouse, a button, a microphone, a switch, a sensor, a global positioning system sensor, an accelerometer, a gyroscope, and/or an actuator. Output component 850 enables device 800 to provide output, such as via a display, a speaker, and/or a light-emitting diode. Communication component 860 enables device 800 to communicate with other devices via a wired connection and/or a wireless connection. For example, communication component 860 may include a receiver, a transmitter, a transceiver, a modem, a network interface card, and/or an antenna.

Device 800 may perform one or more operations or processes described herein. For example, a non-transitory computer-readable medium (e.g., memory 830) may store a set of instructions (e.g., one or more instructions or code) for execution by processor 820. Processor 820 may execute the set of instructions to perform one or more operations or processes described herein. In some implementations, execution of the set of instructions, by one or more processors 820, causes the one or more processors 820 and/or the device 800 to perform one or more operations or processes described herein. In some implementations, hardwired circuitry is used instead of or in combination with the instructions to perform one or more operations or processes described herein. Additionally, or alternatively, processor 820 may be configured to perform one or more operations or processes described herein. Thus, implementations described herein are not limited to any specific combination of hardware circuitry and software.

The number and arrangement of components shown in FIG. 8 are provided as an example. Device 800 may include additional components, fewer components, different components, or differently arranged components than those shown in FIG. 8. Additionally, or alternatively, a set of components (e.g., one or more components) of device 800 may perform one or more functions described as being performed by another set of components of device 800.

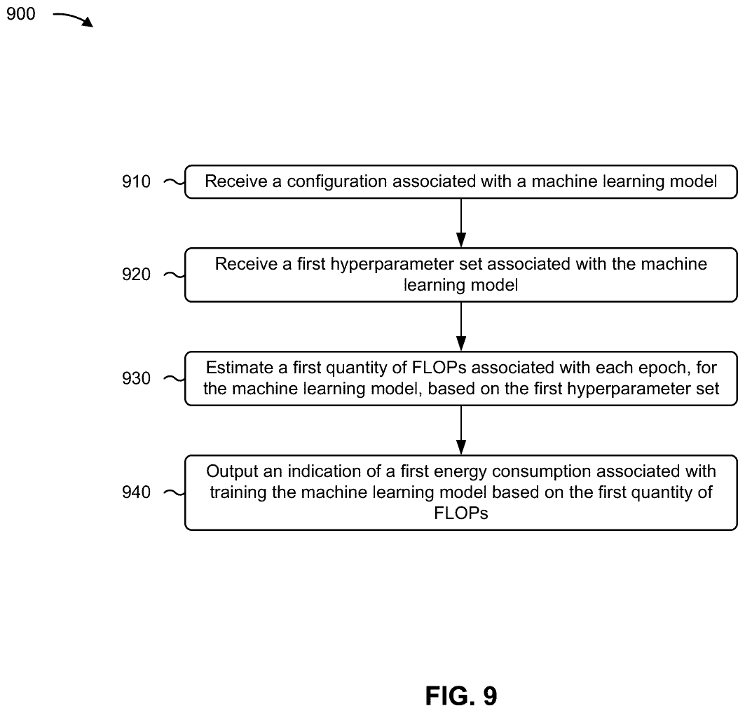

FIG. 9 is a flowchart of an example process 900 associated with determining energy usage for a machine learning model. In some implementations, one or more process blocks of FIG. 9 are performed by a system (e.g., model analysis system 701). Additionally, or alternatively, one or more process blocks of FIG. 9 may be performed by one or more components of device 800, such as processor 820, memory 830, input component 840, output component 850, and/or communication component 860.

As shown in FIG. 9, process 900 may include receiving a configuration associated with a machine learning model (block 910). For example, the model analysis system may receive a configuration associated with a machine learning model, as described herein.

As further shown in FIG. 9, process 900 may include receiving a first hyperparameter set associated with the machine learning model (block 920). For example, the model analysis system may receive a first hyperparameter set associated with the machine learning model, as described herein.

As further shown in FIG. 9, process 900 may include estimating a first quantity of FLOPs associated with one or more epochs, for the machine learning model, based on the first hyperparameter set (block 930). For example, the model analysis system may estimate a first quantity of FLOPs associated with one or more epochs, for the machine learning model, based on the first hyperparameter set, as described herein.

As further shown in FIG. 9, process 900 may include outputting, to a user, an indication of a first energy consumption associated with training the machine learning model based on the first quantity of FLOPs (block 940). For example, the model analysis system may output, to a user, an indication of a first energy consumption associated with training the machine learning model based on the first quantity of FLOPs, as described herein.

Process 900 may include additional implementations, such as any single implementation or any combination of implementations described below and/or in connection with one or more other processes described elsewhere herein.

In a first implementation, process 900 further includes receiving an indication of hardware to be used for training the machine learning model, and determining the first energy consumption associated with training the machine learning model based on a TDP associated with the hardware.

In a second implementation, alone or in combination with the first implementation, process 900 further includes outputting, to the user, an indication of a recommended optimization algorithm for the machine learning model, where the configuration associated with the machine learning model includes an optimization algorithm selected by the user.

In a third implementation, alone or in combination with one or more of the first and second implementations, process 900 further includes estimating a second quantity of FLOPs associated with the one or more epochs, for the machine learning model, based on a second hyperparameter set, and outputting, to the user, an indication of a second energy consumption associated with training the machine learning model based on the second quantity of FLOPs.

In a fourth implementation, alone or in combination with one or more of the first through third implementations, outputting the indication of the first energy consumption and outputting the indication of the second energy consumption include outputting a visual graph of the first energy consumption and the second energy consumption relative to the first hyperparameter set and the second hyperparameter set.

In a fifth implementation, alone or in combination with one or more of the first through fourth implementations, the visual graph further includes variations of the first energy consumption and the second energy consumption relative to quantities of the one or more epochs.

In a sixth implementation, alone or in combination with one or more of the first through fifth implementations, process 900 further includes estimating a plurality of accuracy values associated with corresponding quantities of epochs, for the machine learning model, based on the first hyperparameter set, and determining a plurality of energy consumptions, including the first energy consumption, associated with training the machine learning model and corresponding to the plurality of accuracy values.

In a seventh implementation, alone or in combination with one or more of the first through sixth implementations, outputting the indication of the first energy consumption includes outputting a visual graph of the plurality of accuracy values relative to the plurality of energy consumptions.

In an eighth implementation, alone or in combination with one or more of the first through seventh implementations, process 900 further includes indicating, on the visual graph, a portion associated with an inflection point.

Although FIG. 9 shows example blocks of process 900, in some implementations, process 900 includes additional blocks, fewer blocks, different blocks, or differently arranged blocks than those depicted in FIG. 9. Additionally, or alternatively, two or more of the blocks of process 900 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a device, a configuration associated with a machine learning model;
receiving, by the device, a first hyperparameter set associated with the machine learning model;
estimating, by the device, a first quantity of floating point operations (FLOPs) associated with one or more epochs, for the machine learning model, based on the first hyperparameter set; and
outputting, to a user, an indication of a first energy consumption associated with training the machine learning model based on the first quantity of FLOPs.

2. The method of claim 1, further comprising:
receiving, by the device, an indication of hardware to be used for training the machine learning model; and
determining, by the device, the first energy consumption associated with training the machine learning model based on a thermal design power (TDP) associated with the hardware.

3. The method of claim 1, further comprising:
outputting, to the user, an indication of a recommended optimization algorithm for the machine learning model,
wherein the configuration associated with the machine learning model includes an optimization algorithm selected by the user.

4. The method of claim 1, further comprising:
estimating, by the device, a second quantity of FLOPs associated with the one or more epochs, for the machine learning model, based on a second hyperparameter set; and
outputting, to the user, an indication of a second energy consumption associated with training the machine learning model based on the second quantity of FLOPs.

5. The method of claim 4, wherein outputting the indication of the first energy consumption and outputting the indication of the second energy consumption comprises:
outputting a visual graph of the first energy consumption and the second energy consumption relative to the first hyperparameter set and the second hyperparameter set.

6. The method of claim 5, wherein the visual graph further includes variations of the first energy consumption and the second energy consumption relative to quantities of the one or more epochs.

7. The method of claim 1, further comprising:
estimating, by the device, a plurality of accuracy values associated with corresponding quantities of epochs, for the machine learning model, based on the first hyperparameter set; and
determining, by the device, a plurality of energy consumptions, including the first energy consumption, associated with training the machine learning model and corresponding to the plurality of accuracy values.

8. The method of claim 7, wherein outputting the indication of the first energy consumption comprises:
outputting a visual graph of the plurality of accuracy values relative to the plurality of energy consumptions.

9. The method of claim 8, further comprising:
indicating, on the visual graph, a portion associated with an inflection point.

10. A device, comprising:
one or more memories; and
one or more processors, communicatively coupled to the one or more memories, configured to:
receive a configuration associated with a machine learning model;
receive a first hyperparameter set associated with the machine learning model;
estimate a first quantity of floating point operations (FLOPs) associated with one or more epochs, for the machine learning model, based on the first hyperparameter set; and
output, to a user, an indication of a first energy consumption associated with training the machine learning model based on the first quantity of FLOPs.

11. The device of claim 10, wherein the one or more processors are further configured to:
receive an indication of hardware to be used for training the machine learning model; and
determine the first energy consumption associated with training the machine learning model based on a thermal design power (TDP) associated with the hardware.

12. The device of claim 10, wherein the one or more processors are further configured to:
output, to the user, an indication of a recommended optimization algorithm for the machine learning model,
wherein the configuration associated with the machine learning model includes an optimization algorithm selected by the user.

13. The device of claim 10, wherein the one or more processors are further configured to:
estimate a second quantity of FLOPs associated with the one or more epochs, for the machine learning model, based on a second hyperparameter set; and
output, to the user, an indication of a second energy consumption associated with training the machine learning model based on the second quantity of FLOPs.

14. The device of claim 13, wherein the one or more processors, to output the indication of the first energy consumption and output the indication of the second energy consumption, are configured to:
output a visual graph of the first energy consumption and the second energy consumption relative to the first hyperparameter set and the second hyperparameter set.

15. The device of claim 14, wherein the visual graph further includes variations of the first energy consumption and the second energy consumption relative to quantities of the one or more epochs.

16. The device of claim 10, wherein the one or more processors are further configured to:
estimate a plurality of accuracy values associated with corresponding quantities of epochs, for the machine learning model, based on the first hyperparameter set; and
determine a plurality of energy consumptions, including the first energy consumption, associated with training the machine learning model and corresponding to the plurality of accuracy values.

17. The device of claim 16, wherein the one or more processors, to output the indication of the first energy consumption, are configured to:
output a visual graph of the plurality of accuracy values relative to the plurality of energy consumptions.

18. The device of claim 17, wherein the one or more processors are further configured to:
indicate, on the visual graph, a portion associated with an inflection point.

19. A non-transitory computer-readable medium storing a set of instructions, the set of instructions comprising:
one or more instructions that, when executed by one or more processors of a device, cause the device to:
receive a configuration associated with a machine learning model;
receive a first hyperparameter set associated with the machine learning model;
estimate a first quantity of floating point operations (FLOPs) associated with one or more epochs, for the machine learning model, based on the first hyperparameter set; and
output, to a user, an indication of a first energy consumption associated with training the machine learning model based on the first quantity of FLOPs.

20. The non-transitory computer-readable medium of claim 19, wherein the one or more instructions, when executed by the one or more processors, further cause the device to:
estimate a plurality of accuracy values associated with corresponding quantities of epochs, for the machine learning model, based on the first hyperparameter set; and
determine a plurality of energy consumptions, including the first energy consumption, associated with training the machine learning model and corresponding to the plurality of accuracy values.
